(19) United States
(12) Patent Application Publication
(10) Pub. No.: US 2003/0095222 A1
(43) Pub. Date: May 22, 2003

(54) In-plane switching mode liquid crystal display for preventing crosstalk produced between adjacent data line and common electrode

(76) Inventor: I Fang Wang, Chang-Hwa (TW)

Correspondence Address: Tim Tingkang Xia, Esq., NEEDLE & ROSENBERG, P.C., The Candler Building, Suite 1200, 127 Peachtree Street, N.E., Atlanta, GA, 30303-1811, US

(21) Appl. No.: 10/122,265

(22) Filed: Apr. 11, 2002

(30) Foreign Application Priority Data
Nov. 19, 2001 (TW) 90128592

(51) Int. Cl. G02F 1/1343

(52) U.S. Cl. 349/141

(57) ABSTRACT

An in-plane switching mode liquid crystal display (IPS-LCD) for preventing crosstalk between adjacent data line and common electrode. The IPS-LCD has a lower substrate, an upper substrate and a liquid crystal layer disposed in the space between the lower substrate and the lower substrate. A plurality of transverse-extending gate lines and lengthwise-extending data lines are patterned on the inner surface of the lower substrate to define a plurality of pixel areas arranged in a matrix form. A plurality of lengthwise-extending common electrodes is formed within each pixel area on the inner surface of the lower substrate. A plurality of lengthwise-extending pixel electrodes is formed within each pixel area on the inner surface of the lower substrate, wherein the pixel electrodes are disposed at intervals of the common electrode within each pixel area. A shielding electrode layer is formed on the inner surface of the upper substrate to cover the data line.

### BACKGROUND OF THE INVENTION

1. Field of the Invention

The present invention relates to an In-Plane Switching mode liquid crystal display (IPS-LCD) and, more particularly, to an IPS-LCD for preventing crosstalk produced between adjacent data line and common electrode.

2. Description of the Related Art

In-Plane Switching mode liquid crystal display (IPS-LCD) has been used or suggested in wide viewing angle display technology. Compared with a conventional twisted nematic (TN)-LCD, the IPS-LCD has common electrodes and pixel electrodes formed on a lower glass substrate (TFT substrate) and an in-plane electrode field therebetween is generated to rearrange the liquid crystal molecules along the electrode field. Accordingly, the IPS-LCD device can improve viewing angle, contrast ratio and luminescent efficiency. In order to achieve a better result of the in-plane electrode field, a comb-shaped electrode array has been created to solve problems such as insufficient aperture ratio, crosstalk produced between data lines and common electrodes, and increasing masks used in patterning.

FIG. 1 is a schematic diagram showing a comb-shaped electrode array of a conventional IPS-LCD. A pixel area 10 is a rectangular region defined by two transverse-extending gate lines 12 and two lengthwise-extending data lines 14, in which a TFT structure 15, a comb-shaped pixel electrode 16 and a comb-shaped common electrode 18 are formed. The teeth 16a and 16b of the pixel electrode 16 are disposed at the intervals of the teeth 18a, 18b and 18c of the common electrode 18 and are parallel thereto. After the common electrode 18 and the pixel electrode 16 are grounded, an in-plane electrode field between the teeth 18a, 18b and 18c of the common electrode 18 and the teeth 16a and 16b of the pixel electrode 16 are generated to rearrange the liquid crystal molecules along the electrode field.

FIG. 2 is a sectional diagram showing the conventional IPS-LCD along line I-I′ shown in FIG. 1. The conventional IPS-LCD comprises an upper substrate 1a, a lower substrate 1b, and a liquid crystal layer 2 disposed in the space between the pair of substrates 1a and 1b. On the inner surface of the lower substrate 1a, the gate lines 12 and the common electrode 18 are patterned on the same level plane, an insulating layer 3 is formed to cover the gate lines 12 and the common electrode 18, the data liens 14 and the pixel electrode 16 are patterned on the insulating layer 3, and a first alignment layer 5a is formed to cover the data liens 14 and the pixel electrode 16. On the inner surface of the upper substrate 1b, a black matrix layer 7 is patterned to cover the gate line 12, the data line 14 and the TFT structure 15, a color filter layer 8 is formed on the black matrix layer 7 and the exposed surface of he upper substrate 1b, and a second alignment layer 5b is formed on the color filter layer 7. In order to improve light efficiency, the black matrix 7 is opaque resin to conduct the incident light into the pixel area 10. In addition, a lower polarizer 9a and an upper polarizer 9b are disposed on the outer surfaces of the lower substrate 1a and the upper substrate 1b, respectively.

However, since the data line 14, the pixel electrode 16 and the common electrode 18 are formed on the lower substrate 1a, an in-plane electric field is also produced between the adjacent data line 14 and tooth 18a of the common electrode 18 after an outer voltage is applied to drive the conventional IPS-LCD. This produces crosstalk and influences electrical performance of the conventional IPS-LCD.

### SUMMARY OF THE INVENTION

The present invention provides a shielding electrode structure on the upper substrate of the IPS-LCD with a comb-shaped electrode array to eliminate crosstalk between the adjacent data line and common electrode.

The in-plane switching mode liquid crystal display (IPS-LCD) is used to prevent crosstalk produced between adjacent data line and common electrode. The IPS-LCD has a lower substrate, an upper substrate and a liquid crystal layer disposed in the space between the lower substrate and the lower substrate. A plurality of transverse-extending gate lines and lengthwise-extending data lines are patterned on the inner surface of the lower substrate to define a plurality of pixel areas arranged in a matrix form. A plurality of lengthwise-extending common electrodes is formed within each pixel area on the inner surface of the lower substrate. A plurality of lengthwise-extending pixel electrodes is formed within each pixel area on the inner surface of the lower substrate, wherein the pixel electrodes are disposed at intervals of the common electrode within each pixel area. A shielding electrode layer is formed on the inner surface of the upper substrate to cover the data line.

Accordingly, it is a principle object of the invention to provide the shielding electrode layer on the upper substrate to prevent crosstalk produced between the data line and the common electrode.

It is another object of the invention to provide metal shielding between the data line and the common electrode.

Yet another object of the invention is to provide the shielding electrode layer on the upper substrate to function as a black matrix layer.

These and other objects of the present invention will become readily apparent upon further review of the following specification and drawings.

### BRIEF DESCRIPTION OF THE DRAWINGS

FIG. 1 is a schematic diagram showing a conventional comb-shaped electrode array.

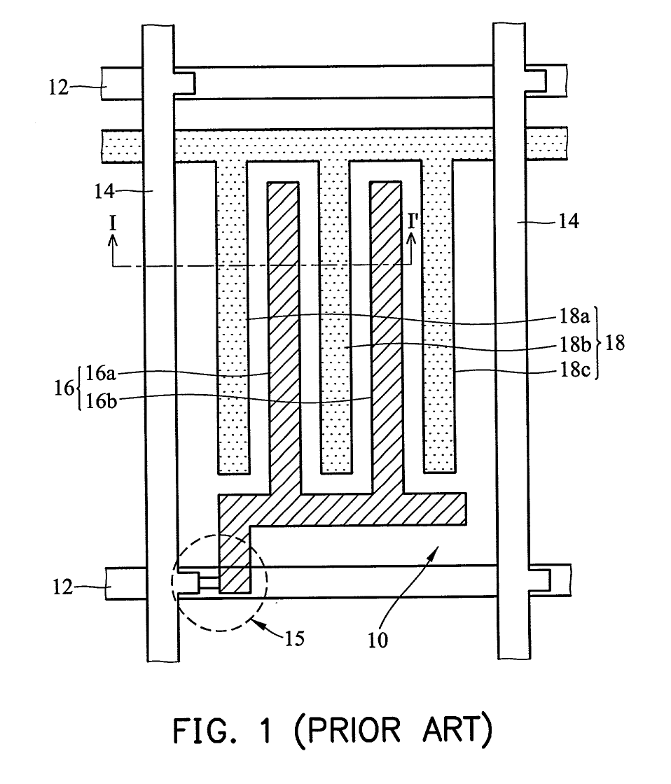

FIG. 2 is a sectional diagram showing the conventional IPS-LCD along line I-I′ shown in FIG. 1.

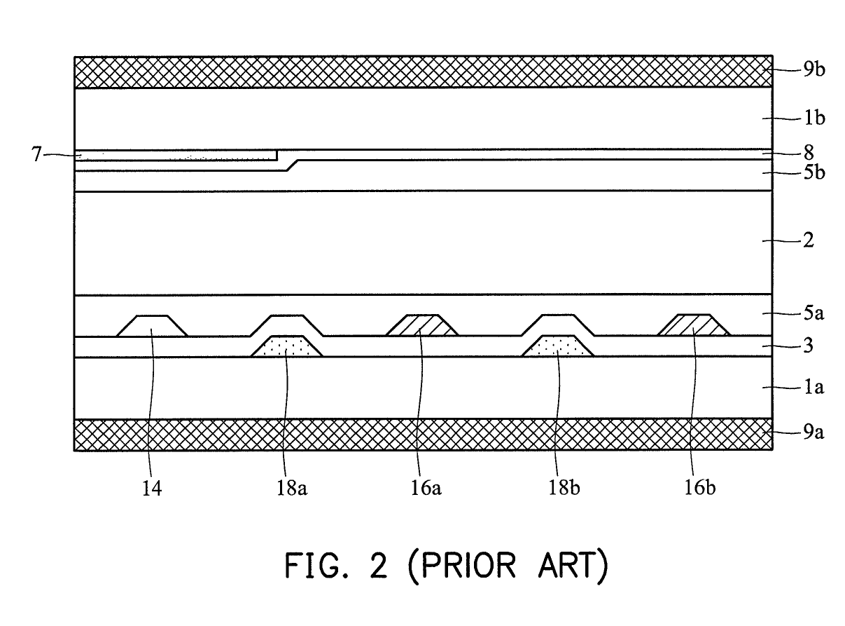

FIG. 3 is a sectional diagram showing an IPS-LCD according to the first embodiment of the present invention.

FIG. 4 is a sectional diagram showing an IPS-LCD according to the second embodiment of the second present invention.

Similar reference characters denote corresponding features consistently throughout the attached drawings.

### DETAILED DESCRIPTION OF THE PREFERRED EMBODIMENTS

The present invention provides a shielding electrode layer on an upper substrate of an IPS-LCD with comb-shaped electrode array on a lower substrate. Preferably, the shielding electrode layer is over the data line to provide a metal shielding effect between the adjacent data line and common electrode, thus crosstalk produced therebetween is eliminated. Further, for simplifying the IPS-LCD process, a black matrix can be formed as an opaque electrode layer and applied with a common voltage to serve as the shielding electrode layer.

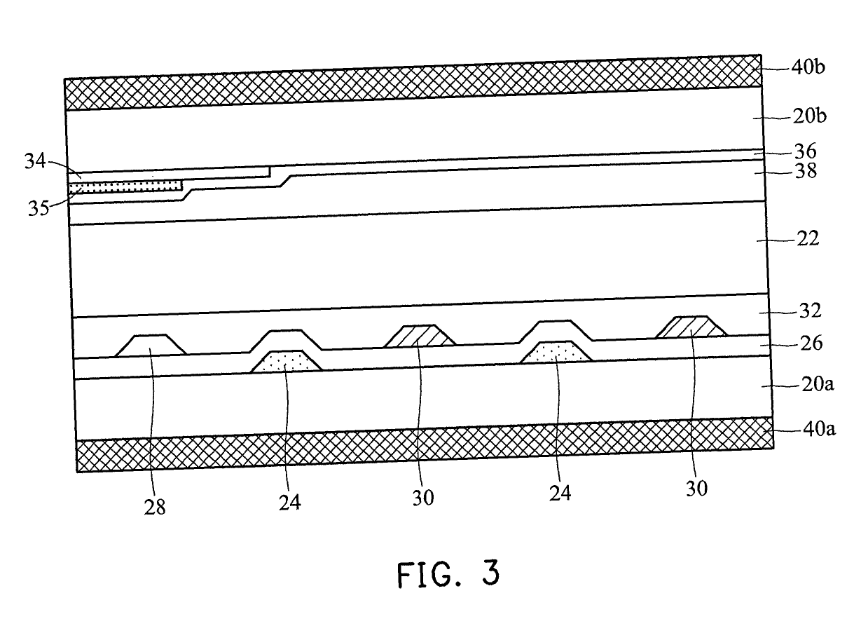

FIG. 3 is a sectional diagram showing an IPS-LCD according to the first embodiment of the present invention. The IPS-LCD comprises a lower substrate 20a, an upper substrate 20b parallel to the lower substrate 20a, and a liquid crystal layer 22 formed in the space between the pair of the substrates 20a and 20b. The lower substrate 20a serves as a TFT substrate. On the inner surface of the lower substrate 20a, two transverse-extending gate lines and two lengthwise-extending data lines 28 define a plurality of pixel areas arranged in a matrix form. In the pixel area, a plurality of common electrodes 24 are patterned on the same level plane with the gate lines, an insulating layer 26 is formed to cover the gate lines and the common electrodes 24, the data lines 28 are patterned on the insulating layer 26, a plurality of pixel electrodes 30 are patterned on the insulating layer 26 and disposed at the intervals of the common electrodes 24, and a first alignment layer 32 is formed to cover the data lines 28 and the pixel electrodes 30. Depending on requirements of process and electrical performance, various designs of electrode structure can be used to form the common electrode 24 and the pixel electrode 30, such as a comb-shaped electrode array.

The upper substrate 20b serves as a color filter substrate. A black matrix layer 34 is formed on the inner surface of the upper substrate 20b, to cover the gate line, the data line 28 and the TFT structure to effectively conduct incident light into the pixel area. Also, a shielding electrode layer 35 is formed on the black matrix layer 34 to cover the data line 28. Further, a color filter layer 36 is formed to cover the shielding electrode layer 35, the black matrix layer 34 and the exposed inner surface of the upper substrate 20b, and a second alignment layer 38 is formed on the color filter layer 36. Moreover, a lower polarizer 40a and an upper polarizer 40b are formed on the outer surface of the lower substrate 20a and the upper substrate 20b, respectively.

The black matrix layer 34 may be resin or other light-shielding materials. The shielding electrode layer 35 may be indium tin oxide (ITO), chromium (Cr) or other metallic materials. The size and profile of the shielding electrode layer 25 are design choices. By deposition, photolithography and etching, the shielding electrode layer 35 can be formed as a strip-shaped pattern, a pattern similar to the data line 28 or any other patterns if only the shielding electrode layer 35 covers the data line 28. The size of the shielding electrode layer 35 may be smaller than or equal to that of the black matrix layer 34. The shielding electrode layer 35 provides metal shielding effect between the adjacent data line 28 and common electrode 24, thus preventing the voltage of the pixel area affected from the voltage of the data line 28 so as to eliminate crosstalk.

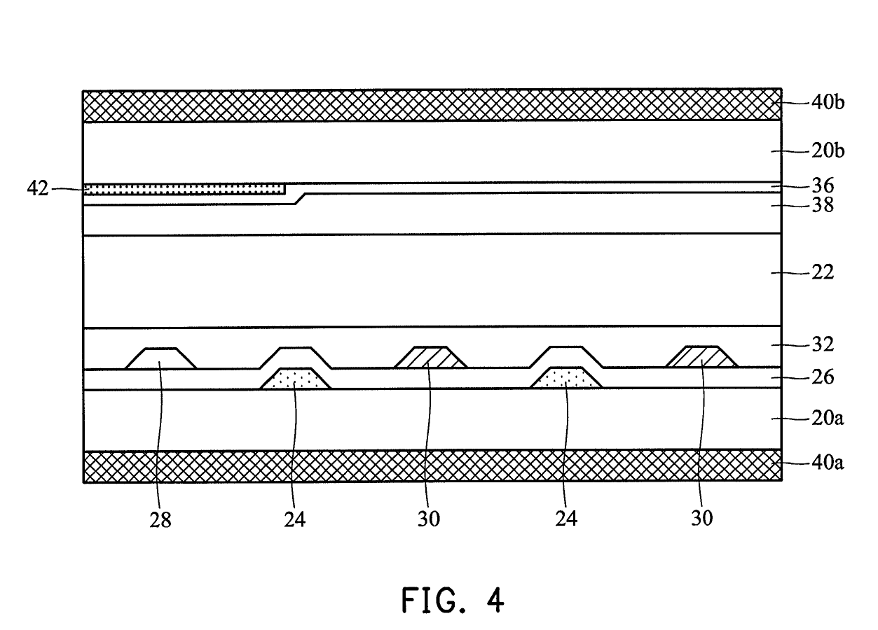

FIG. 4 is a sectional diagram showing an IPS-LCD according to the second embodiment of the second present invention. In order to simplify the IPS-LCD process, the black matrix layer 34 may be Cr or other opaque metallic materials with a common voltage to serve as an opaque auxiliary electrode 42, and the fabrication of the shielding electrode layer 35 is omitted. Thus, the opaque auxiliary electrode 42 functions as the black matrix layer 34 and the shielding electrode layer 35.

It is to be understood that the present invention is not limited to the embodiments described above, but encompasses any and all embodiments within the scope of the following claims.

What is claimed is:

1. An in-plane switching mode liquid crystal display (IPS-LCD) comprising:
a first substrate and a second substrate disposed parallel to each other;
a liquid crystal layer disposed in the space between the first substrate and the first substrate;
a plurality of transverse-extending gate lines and lengthwise-extending data lines patterned on the inner surface of the first substrate to define a plurality of pixel areas arranged in a matrix form;
a plurality of lengthwise-extending common electrodes formed within each pixel area on the inner surface of the first substrate;
a plurality of lengthwise-extending pixel electrodes formed within each pixel area on the inner surface of the first substrate, wherein the pixel electrodes are disposed at intervals of the common electrode within each pixel area; and
a shielding electrode layer formed on the inner surface of the second substrate to at least cover the data line.

2. The IPS-LCD according to claim 1, wherein the shielding electrode layer is of opaque metallic materials.

3. The IPS-LCD according to claim 1, wherein the shielding electrode layer is chromium.

4. The IPS-LCD according to claim 1, further comprising a black matrix layer formed on the inner surface of the second substrate.

5. The IPS-LCD according to claim 4, wherein the shielding electrode layer is patterned on the black matrix layer to cover the data line.

6. The IPS-LCD according to claim 5, wherein the shielding electrode layer is indium tin oxide (ITO), chromium (Cr) or other metallic materials.
